(19) United States
(12) Patent Application Publication
(10) Pub. No.: US 2005/0206936 A1
(43) Pub. Date: Sep. 22, 2005

(54) Improvements in and relating to printing

(76) Inventors: Andrew Robert Byde, Pontcanna Cardiff (GB); Paul Layzell, Lydney (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/084,705

(22) Filed: Mar. 18, 2005

(30) Foreign Application Priority Data
Mar. 20, 2004 (GB) 0406314.5

(51) Int. Cl. G06F 15/00

(52) U.S. Cl. 358/1.12; 358/1.18

(57) ABSTRACT

Disclosed is a printer (10) for printing images to print media (18), comprising: a sheet feeder (14) for receiving a sheet of print media (18); a memory for storing information related to an image previously printed to the sheet of print media. The printer (10) is operable to print a new image to the print media (18), said image being positioned according to the stored information in the memory, such that the new image is printed at a position on the print media where it does not overlap with the previously printed image.

The present invention relates to printers, and particularly to printers suitable for printing images from a digital camera or camera-equipped telephone, either preferably directly from the camera, or from an intermediate personal computer.

Developments in printers intended for the domestic and small-business market have resulted in photo-quality devices being available at reasonable cost, where previously their relatively prohibitive price prevented their widespread use outside specialist fields. A continuing problem, however, is the relatively high cost of print media, e.g. photo-quality paper, for use with such devices.

Most often, photo-quality printers are arranged to accept print paper in a range of sizes. Typically, such printers accept paper in commonly manufactured standard sizes such as A4 and A5.

Typically, photographs from film cameras that have been developed and printed chemically are of a smaller size, typically 6×4 inches or 7×5 inches. Such sizes are typically well provided with standardised photo frames, picture albums and the like. It is not common for albums and frames to be provided in A4, A5 or other commonly used print-paper sizes.

Many digital camera owners would like to print pictures at home that are sized more like traditional photographs, so that they may make use of standard photo albums and the like. A problem with domestic photo-quality printers is that it can be very wasteful to print only a single 6×4 inch photograph on a sheet of A4 paper. The cost of a single sheet of paper can make this option more expensive than getting a particular picture printed professionally, thus negating one of the benefits of being able to print pictures at home.

Various ad-hoc methods may be employed by users wishing to maximise their use of a piece of photo-quality printer paper. They may use specialised software which will allow several pictures to be ‘tiled’ onto a single sheet and printed in one go, thus maximising the use of the available print area. However, this requires a user to have several pictures ready for printing at a single time, and requires the user to have a PC and be skilled at using image-processing software.

Users may attempt to manually manipulate the printing of a particular image so that it fits into the available white space of a sheet which has already been partially printed to. This technique can result in overprinting the existing image which is obviously undesirable.

According to the present invention, there is provided a printer for printing images to print media, comprising: a sheet feeder for receiving a sheet of print media; a memory for storing information related to an image previously printed to the sheet of print media; wherein the printer is operable to print a new image to the print media, said image being positioned according to the stored information in the memory, such that the new image is printed at a position on the print media where it does not overlap with the previously printed image.

Preferably, the new image is printed adjacent to the location of the previously printed image. Alternatively, each new image may be printed into a different corner of the sheet of print media, depending on the size of the image and the space available. Other alternative schemes may be realised.

Preferably, if the image to be printed is the first image to be printed to the sheet, then the image is printed in a pre-determined location.

Preferably, the predetermined location is specified relative to an edge of the sheet.

Preferably, the first image is printed in a lower left hand corner of the sheet. This has the advantage that, as height measurements are made from the top of the sheet, printed images may be cut out from the sheet without affecting future calculations performed to position new images.

Preferably, the printer is operable to offset the image to be printed, from a previous image, by a given margin. This allows a suitable space to be left around each printed image to ensure that there is no degree of overlap between adjacent images, and that there is sufficient room around each image to facilitate simple separation of the images.

Preferably, the printer is operable to enable a user to alter the given margin. In this way, if the user wishes to achieve a particular effect, such as large white borders, he is able to do so.

Preferably, before an image is printed, the printer is operable to compare the dimensions of the image to be printed with the space available on the sheet.

Preferably, the printer is operable to firstly compare the width of the image to be printed with the width of space available next to the previously printed image, such that if there is sufficient width available then the height of the image is checked to ensure that sufficient height is available on the sheet, and if sufficient height is available, the image to be printed is located alongside the position of the previously printed image.

Preferably, if insufficient width is available to print the image, then the printer is operable to determine if there is sufficient height above the previously printed image or images to accommodate the image to be printed, and if there is sufficient height and width available, printing the image on the sheet, above the highest point of the previously printed image or images.

Preferably, if there is insufficient space available on the sheet of print media then the printer is operable to alert the user to take remedial action. Such remedial action may include editing the picture using a computer or other device so that it will fit, or inserting a new sheet of print media.

Preferably, the printer is operable to alert the user via a message displayed on a display panel of the printer.

Preferably, the printer is operable to alert the user via a message printed onto the sheet of print media.

Preferably, the printer is further operable to print each new image onto a new sheet of print media. In this mode, no attempt is made to print more than one image to a sheet.

Preferably, the printer includes input means for allowing a user to control a mode of operation of the printer. Such means could include a control panel having one or more controls such as switches or push-buttons.

Preferably, the printer is operable to detect dimensions of a sheet of print media input to the printer. The printer may be operable to perform this task via means of one or more optical sensors.

Preferably, the printer is operable to receive input data relating to dimensions of a sheet of print media input to the printer.

Preferably, the input data is entered manually by user.

Preferably, the input data is received from a connected device.

For a better understanding of the present invention, and to understand how the same may be brought into effect, the invention will be described, by way of example only, with reference to the appended drawings in which:

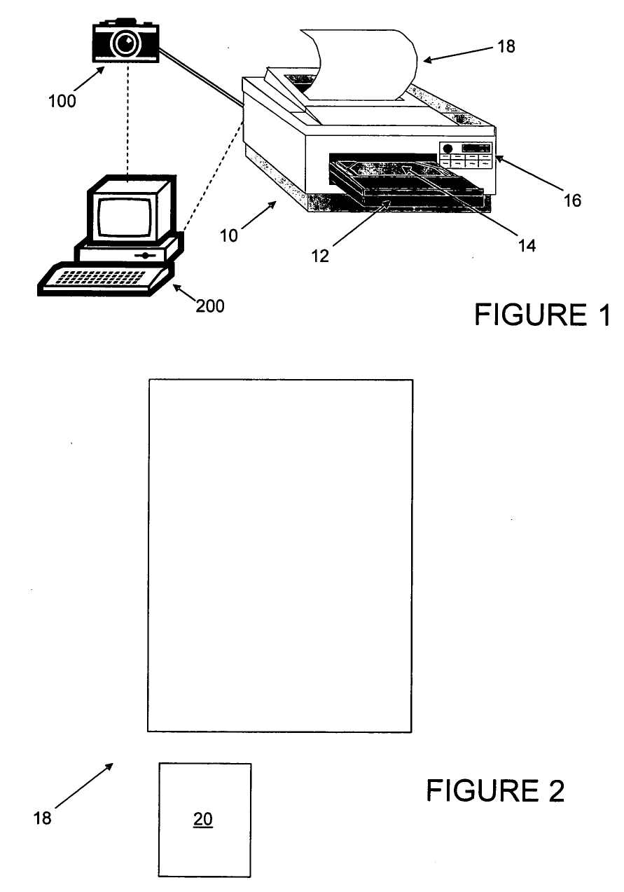

FIG. 1 shows a printer forming an embodiment of the present invention;

FIG. 2 shows a sheet of previously-printed photo-quality printer paper;

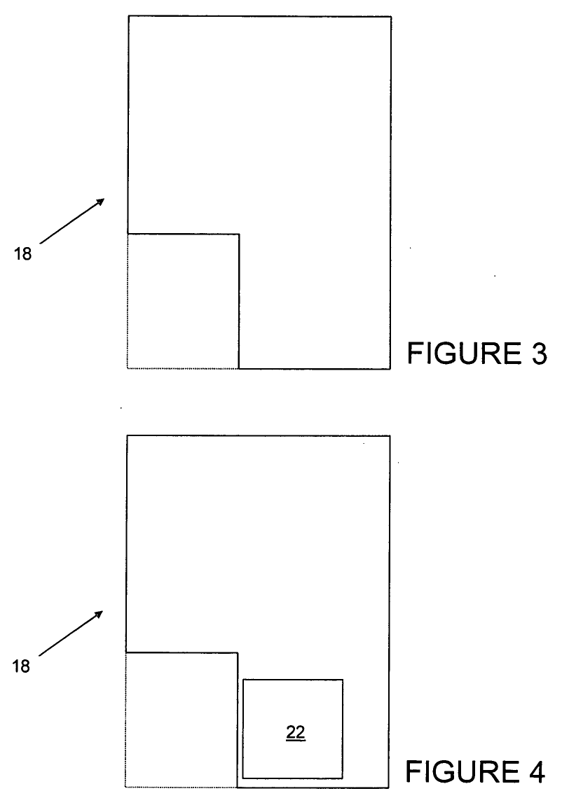

FIG. 3 shows the sheet of FIG. 2 highlighting the non-available area;

FIG. 4 shows the sheet of FIG. 3 printed with a new image;

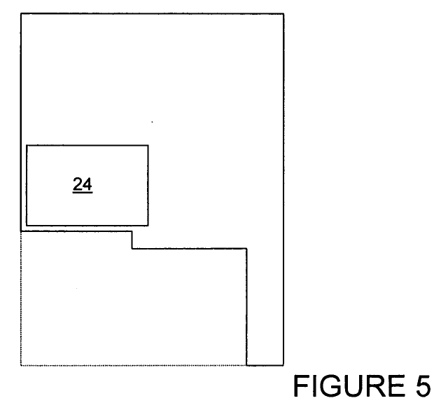

FIG. 5 shows the sheet of FIG. 4 printed with a new image;

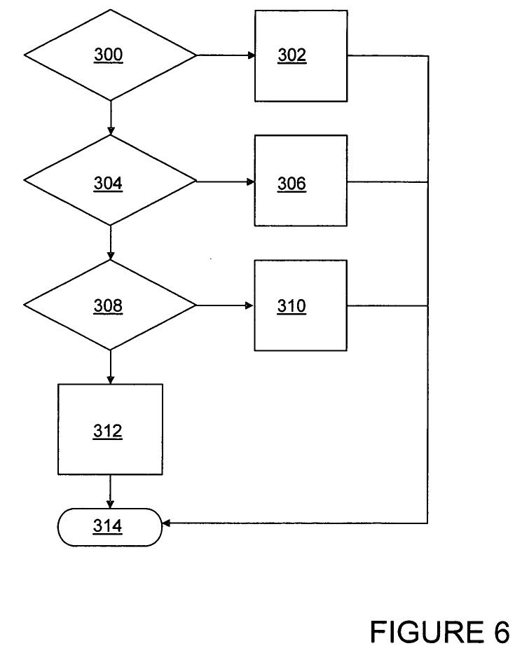

FIG. 6 shows a flowchart depicting a method according to an embodiment of the invention.

FIG. 1 shows a printer 10 according to an embodiment of the present invention. The printer externally resembles many prior art printers, and users would not notice very many, if any, differences from examining its external appearance. The printer operates according to one of many well known techniques to produce photo-quality prints. Such techniques include colour inkjet printing and colour laser printing. The actual technique used is not important with regard to the invention.

The printer 10 includes a sheet feeder device 12, which in this case incorporates a cartridge including several sheets of print media. The printer also features a manual feed mechanism 14 which allows a single sheet to be fed into the printer in preference to taking a sheet from the cartridge.

The printer has a control panel 16 which includes one or more keys, switches or buttons which enable various different functions to be activated. The control panel also includes a display which may show various menu options in response to actuation of one or more of the keys.

Also shown in FIG. 1 is a sheet of print media 18, being ejected from the upper surface of the printer 10, having been printed to.

The printer 10 is shown connected to a camera 100 and/or a computer 200. The printer 10 may be arranged to receive images directly from the camera 100, as indicated by the double line shown. Alternatively, the printer 10 may receive images from the camera 100 via an intermediate computer 200, as indicated by the broken line shown. Of course, the printer 10 can also receive images from the computer 200 if such images have not been sourced from the camera 100, but may have been received, for example, via email.

The printer 10 is operable to selectively print a new image to an unused portion of a piece of print media such that said media can be re-used if it has sufficient space available to accommodate the new image. In this way, after each successive image is printed, the user may cut out the new image from the sheet, and the printer ‘remembers’ the details of recently printed images such that one or more new images may be printed to the remainder of the sheet.

The printer is arranged to include memory to store information related to a mode of operation of the printer and a list of areas to which images have already been printed. When the printer is in a mode which prints a current image to a sheet which has already been printed onto, the printer is operable to print the image in a location on the sheet that takes into account previously printed images which may still be present on the sheet or, which may have been removed from the sheet. For convenience, this mode of printer operation will be referred to as ‘paper re-use’ mode.

In a preferred embodiment, the list of areas includes details of each area/image which has already been printed to the current sheet.

The list is arranged so that each area is defined in terms of a rectangle having a lower left co-ordinate (x,y), a width and a height. The list additionally includes two further variables Z1 and Z2. Z1 is set to equal the position of the bottom of the current row where images may be printed. Z2 is set to equal the position of the top of the current row where images may be printed.

The following example of successive images being printed in paper re-use mode illustrates how embodiments of the invention operate to print new images to unused portions of already-used print media.

A printer is provided with a blank sheet of A4 sized photo quality printer paper. A4 paper is a standard paper size of 29.7 cm height and 21.0 cm width. In practice, not all of the paper is printable to due to the constraints of feeding the paper into the printer mechanism and securing it in place during printing. In this example, the printable area of the paper surface measures 28 cm×20 cm.

The printer is aware of the size of printer paper in use at any time, and can set the following variables:
page_width 20
page_height=28

At initialisation, the variables Z1 and Z2 are set:
Z1=Z2=page_height=28

The printer is arranged to print images at co-ordinates (X,Y), where (X,Y) signifies the lower left corner of the printed image.

Image 1

FIG. 2 illustrates the scenario where a first image 20 is to be printed to a previously blank sheet. The printer receives data indicating that an image 20 is to be printed. The data may be received via a connected personal computer, or from some other device, such as a digital camera or mobile telephone. The image measures 6 cm (width)×8 cm (height).

The printer is aware that no image has yet been printed to the current sheet, and so the co-ordinates (X,Y) of the image are initially set to:
X=0
Y=Z2=28

The X and Y co-ordinates have an origin at the top left corner of the paper as shown in FIG. 2.

The printer is operable to check that the width of the image can be accommodated in the remaining space:
X+width=6 (which is less than the 20 available)
Z1=min(Z1, Y-height)=min(28, 28−8)=20
Z1 is not <0, so print the object at (X,Y)=(0,28)

The image 20 is thus printed in the lower left corner of the sheet as shown in FIG. 2.

FIG. 3 shows that a user may elect to cut out the image from the sheet, as indicated by the dotted line. In this way, there is no need to fill an entire sheet with images before the individual images can be separated.

Image 2

The next image 22 to be printed measures 8 cm (width)×7 cm (height).

X is initially set to the width of the used or printed portion of the sheet, in this case=6
Y=Z2=28

The printer is operable to check that the remaining width is sufficient to accommodate the new image.
X+width=6+8=14 (which is <20)
Z1=min(Z1, Y-height)=min(20, 28−7)=20
Z1 is not <0, so print the object at (X, Y)=(14, 28)

The image 22 is therefore printed to lie alongside the previously printed image 20, or, in this case, to lie alongside the position of the previously printed image, as the image itself has been removed from the paper.

Image 3

The next image 24 to be printed measures 7 cm (width)×5 cm (height).

X is initially set to the width of the used or printed portion of the sheet. In this case, X=6+8=14
Y=Z2=28

The printer is operable to check that the remaining width is sufficient to accommodate the new image.
X+width=14+7=21 (which is >20 and so cannot be accommodated in the remaining space adjacent the previously printed image)

X is then set to 0, effectively forcing the printer to shift the image to the left hand side of the paper. Next, the printer positions the image so that it does not over-print any existing image positioned below it on the sheet. This is done by setting Y=Z1. This may be considered setting the lower bound of the new available printing space to be equal to the upper bound of the previously printed images. In this way, the image which starts this new row is positioned such that it is located above the tallest of any one of the previously printed images, ensuring that no over-printing of a previous image will occur.
Y=Z1=20
Z2=Z1=20
Z1=min(Z1, Y-height)=min(20, 20−5)=15
Z1 is not <0, so print the object at (X,Y)=(0,20)

FIG. 5 illustrates how the new image 24 is located at the left hand edge of the paper in a position above the highest point of any previously printed image.

The above examples show how the printer decides where to print a particular image having regard to the overall size of each image, the printer paper in use and the size and position of previously printed images. As can be seen, the printer makes an evaluation whether the space available in a widthwise direction is sufficient to print the present image. If space is available, then a check is made of space available in a heightwise direction. If space is available, then the image is printed in a location as described above.

If there is insufficient space available in a widthwise direction, then the printer will attempt to print the new image above the already printed images if there is sufficient space available. This process continues until there is no space available on the sheet. In practice, limits may be placed, such that once there is less than a certain printable height and/or width available on the sheet, then a message is displayed instructing the user to commence printing on a new sheet. Alternatively, the image may be cropped or scaled and printed in the available space.

In alternative embodiments of the invention, other placement schemes may be used for positioning further images on the sheet. For example, a first image could be printed into a first corner of the sheet, with subsequent images being progressively added to other corners. Such a scheme could provide a simple way of placing images on a sheet, but may not maximise the number of images which may be printed.

In a preferred embodiment of the invention, a margin of blank space is provided around each image such that there is a suitable space between adjacent images to facilitate cutting, for instance. The examples shown above do not include the calculation of such a margin, but an extra term may be included in each calculation to allow for such a margin. It may be possible for a user to specify dimensions for a suitable margin, or a preset measurement may be used.

Although embodiments of the present invention have been described in terms of specific dimensions labelled ‘width’ and ‘height’, the skilled man will realise that these dimensions may be swapped without affecting the operation of embodiments of the invention in any material manner. In particular, different paper sizes may be used in ‘portrait’ or ‘landscape’ orientations which ay alter the relative meanings of ‘width’ and ‘height’.

In an alternative embodiment of the present invention, a prior art printer may be used to realise the benefits of the present invention. In this embodiment, a device, such as a camera or a computer are arranged to transmit to a prior art printer an image to be printed, together with the co-ordinates for that image, taking into account all the various criteria such as page size, available space and image size as have already been described in relation to the previously described embodiments.

In this way, a user having a prior art printer, but a camera or computer according to an embodiment of the invention, can still enjoy the benefits of the invention.

The method according to an embodiment of the invention, whether performed in a printer as previously described, or in a camera or computer, is shown in FIG. 6. Step 300 detects a mode of operation of the apparatus (camera, printer or computer). If the apparatus is not in ‘paper re-use mode’, then process 302 is performed which prints an image to the sheet in the same way as in prior art systems, i.e. no allowance is made for any item already printed. Flow then stops at step 314.

If the apparatus is in ‘paper re-use mode’, then step 304 checks to see whether the image to be printed is the first one to be printed to the present sheet. If it is, then process 306 prints the image to the default start location on the sheet. Flow then stops at step 314.

If the image to be printed is not the first image to be printed to the present sheet, then step 308 checks to ensure that there is sufficient space available on the present sheet to accommodate the new image according to the placement rules. These rules have already been described and allow new images to be placed adjacent to the existing image(s) if space permits, or other schemes, such as printing each new image in a different corner of the paper may be used. If insufficient space is available then step 310 outputs an error message, and flow stops at step 314.

If sufficient space is available according to the rules used, then step 312 causes the image to be printed at a given location according to the placement rules used. Flow then stops at step 314.

As stated, the steps of the method can be performed in the printer itself, or in a suitable equipped camera or computer, giving maximum flexibility to potential users of embodiments of the invention.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A printer for printing images to print media, comprising:
a sheet feeder for receiving a sheet of print media;
a memory for storing information related to an image previously printed to the sheet of print media;
wherein the printer is operable to print a new image to the print media, said image being positioned according to the stored information in the memory, such that the new image is printed at a position on the print media where it does not overlap with the previously printed image.

2. A printer as claimed in claim 1 wherein the new image is printed adjacent to the location of the previously printed image.

3. A printer as claimed in claim 1 wherein if the image to be printed is the first image to be printed to the sheet, then the image is printed in a pre-determined location.

4. A printer as claimed in claim 3 wherein the predetermined location is specified relative to an edge of the sheet.

5. A printer as claimed in claim 3 wherein the first image is printed in a lower left hand corner of the sheet.

6. A printer according to claim 1 wherein the printer is operable to offset the image to be printed, from a previous image, by a given margin.

7. A printer as claimed in claim 6 wherein the printer is operable to enable a user to alter the given margin.

8. A printer according to claim 1 wherein before an image is printed, the printer is operable to compare the dimensions of the image to be printed with the space available on the sheet.

9. A printer as claimed in claim 8 wherein the printer is operable to firstly compare the width of the image to be printed with the width of space available next to the previously printed image, such that if there is sufficient width available then the height of the image is checked to ensure that sufficient height is available on the sheet, and if sufficient height is available, the image to be printed is located alongside the position of the previously printed image.

10. A printer as claimed in claim 9 wherein if insufficient width is available to print the image, then the printer is operable to determine if there is sufficient height above the previously printed image or images to accommodate the image to be printed, and if there is sufficient height and width available, printing the image on the sheet, above the highest point of the previously printed image or images.

11. A printer as claimed in claim 8 wherein if there is insufficient space available on the sheet of print media then the printer is operable to alert the user to take remedial action.

12. A printer as claimed in claim 11 wherein the printer is operable to alert the user via a message displayed on a display panel of the printer.

13. A printer as claimed in claim 11 wherein the printer is operable to alert the user via a message printed onto the sheet of print media.

14. A printer according to claim 1 wherein the printer is further operable to print each new image onto a new sheet of print media.

15. A printer according to claim 1 wherein the printer includes input means for allowing a user to control a mode of operation of the printer.

16. A printer according to claim 1 wherein the printer is operable to detect dimensions of a sheet of print media input to the printer.

17. A printer according to claim 1 wherein the printer is operable to receive input data relating to dimensions of a sheet of print media input to the printer.

18. A printer as claimed in claim 17 wherein the input data is entered manually by user.

19. A printer as claimed in claim 17 wherein the input data is received from a connected device.

20. A method of printing a new image to a sheet of print media, the sheet having a previously printed image thereon, the method comprising the steps of:
determining the size of the image to be printed;
determining if sufficient space is available on the previously printed sheet;
printing the new image into the available space, such that it does not overlap with the previously printed image.

21. A data carrier including a computer program comprising instructions arranged to carry out the method as claimed in claim 20.
